(19) United States
(12) Patent Application Publication
(10) Pub. No.: US 2006/0083532 A1
(43) Pub. Date: Apr. 20, 2006

(54) Print mode switching influenced by job length

(76) Inventors: Marcos Esterman JR., Rochester, NY (US); Santiago I. Rodriguez, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/969,599

(22) Filed: Oct. 19, 2004

(51) Int. Cl. G03G 15/00

(52) U.S. Cl. 399/82

(57) ABSTRACT

A method for controlling printing in a system that prints both single-color and multicolor documents includes determining the number of documents of a print job, ascertaining that a number of consecutive documents of the print job can be printed in a single-color mode, and switching the printer to the single-color mode based on the ascertaining and the determining step.

### BACKGROUND OF THE INVENTION

In a conventional monochrome laser printer, toner particles are made to adhere to an outer surface of a photoconductive drum by way of static electricity. The process begins with a laser beam being scanned across the length of the photoconductive drum in order to “draw” each character on the surface of the drum. In the areas of the drum illuminated by the laser, the drum retains a static electric charge. In locations of the drum not illuminated by the laser, the drum retains little or no static charge. As the photoconductive drum rotates through the developer (an area loaded with oppositely-charged toner particles) the particles are attracted to the charged regions of the drum that have been illuminated by the laser. As the drum continues to rotate, the drum comes into contact with paper medium, thereby allowing the toner particles to be adhered to the paper. The paper is then exposed to a fuser roller which melts the toner particles on to the paper.

In a color laser printer, a series of photoconductive drums is used to impart toner of different colors onto the paper or other media, with one photoconductive drum being used for each color. Thus, in a four-color laser printer, a first photoconductive drum may impart black (K) toner onto the paper, while a second, third, and fourth drum imparts cyan (C), magenta (M), and yellow (Y) toners onto the paper.

However, many users of laser printers find themselves printing jobs that consist of mainly single-color documents with only a few documents of the print job requiring the printer to print in a multicolor mode. Thus, even though the printer may be printing with only a single-color of toner, all of the photoconductive drums and developer rollers continue to rotate. This causes the toner cartridge, which houses the drum, developer rollers, toner particles and the associated mechanical components, to experience excessive wear and tear. Consequently, one or more of the color toner cartridges may require replacement even though only a small portion of the toner has been consumed. This represents a significant waste to the customer and increases the cost of ownership of a color laser printer.

### BRIEF DESCRIPTION OF THE DRAWINGS

FIG. 1 is a block diagram of a system that performs print mode switching influenced by job length according to a first embodiment of the invention.

FIG. 2 is a graph showing a comparison of various criteria for print mode switching according to an embodiment of the invention.

FIG. 3 is a block diagram of a system that performs print mode switching influenced by job length according to a second embodiment of the invention.

FIG. 4 is a flowchart for a method of print mode switching according to an embodiment of the invention.

### DESCRIPTION OF THE EMBODIMENTS

Embodiments of the invention allow a printer to deactivate unneeded printer resources when at least a portion of a print job does not require color printing. Thus, for the case of a four-color (CMYK) laser printer that prints primarily single-color documents consisting of black (K) toner on white paper, the rotation of the cyan, magenta, and yellow photoconductive drums and developers can be stopped so as to minimize the wear on the non-printing drums and their associated mechanical and electrical components. Further, where each photoconductive drum requires a certain amount of “overhead”, which includes such things as prerotation and post rotation, in which the photoconductive drums and development rollers are rotated prior to printing (prerotation) and after printing (post rotation), embodiments of the invention can be optimized in a manner that balances the need for printer speed (measured in pages or documents per minute) with the need to minimize wear on the mechanical components associated with each photoconductive drum and toner development components.

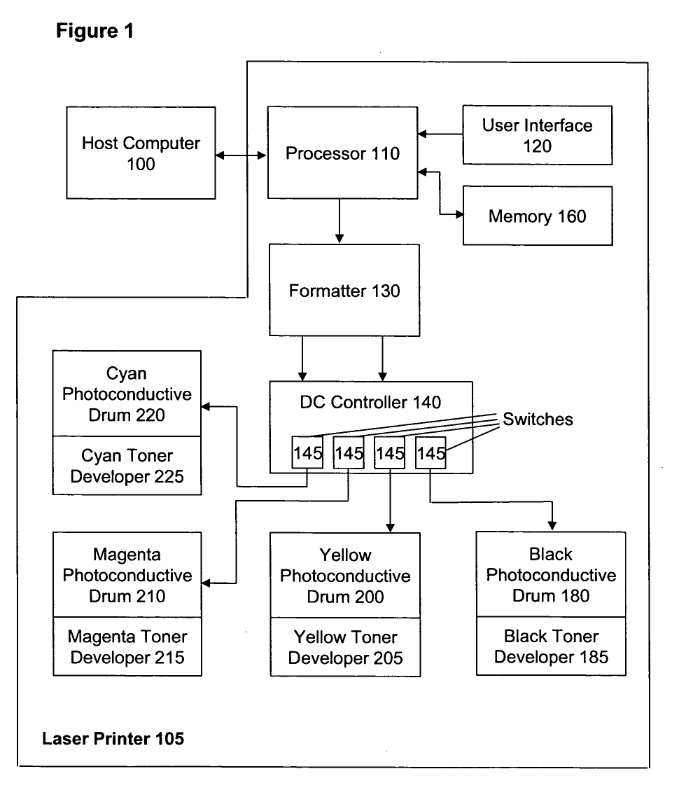

FIG. 1 is a block diagram of a system that performs print mode switching influenced by job length according to a first embodiment of the invention. In FIG. 1, host computer 100 represents a personal computer, server, personal digital assistant, or other computing resource that sends print jobs to laser printer 105. Laser printer 105 includes user interface 120, which is contemplated as including a power on/off switch, as well as other controls that allow the user to control the operation of printer 105 and to receive feedback regarding the status of the printer and of a particular print job. Laser printer 105 is capable of printing multicolor documents consisting of a mixture of cyan, magenta, yellow, and black toners.

Processor 110 receives single-color and multicolor print jobs from host computer 100. Each print job may consist of any combination of text information as well as graphical data distributed among one or more single-page documents that constitute the print job. Processor 110 is coupled to memory 160, which stores the various fonts and other information needed to direct the operations of laser printer 105 as well as to convert printer driver commands into lower-level control information.

Processor 110 is also coupled to formatter 130 which converts the lower-level control information from processor 110 into a series of raster commands. In the embodiment of FIG. 1, these raster commands are in the form of pulses of varying width that are used to control the operations of each of the lasers that scan cyan photoconductive drum 220, magenta photoconductive drum 210, yellow photoconductive drum 200, and black photoconductive drum 180. In response to the pulses from formatter 130, direct current (DC) controller 140 modulates the voltages needed to control the rotation of each of the photoconductive drums using cyan toner developer 225, magenta toner developer 215, yellow toner developer 205, and black toner developer 185.

In the example of FIG. 1, formatter 130 includes outputs for each of the colors associated with the various photoconductive drums and toner developers. These outputs are provided to DC controller 140 at least several documents in advance of the document currently printing. For example, while the first document of a print job is printing, DC controller 140 may be receiving raster commands relevant to the fifth document (that is, page five) of the print job. In this manner, DC controller 140 “looks ahead” into the print queue by at least several documents. By way of this look ahead capability, DC controller 140 can determine which colors are needed in order to print the upcoming documents of the print job. When DC controller 140 determines that a particular color is not needed for at least several documents, the DC controller can activate one or more of switches 145 in order to stop (or to at least slow) the movement of one or more photoconductive drums and toner developer components.

It is contemplated that each of the cyan, magenta, yellow, and black photoconductive drums and toner development components of FIG. 1 performs an amount of prerotation prior to printing a document using a given color. It is also contemplated that each photoconductive drum performs an amount of post rotation after printing a document using a given color. Prerotation provides a mechanism by which toner particles can be charged with static charges by way of triboelectric movement. Additionally, prerotation allows the photoconductive drum to be uniformly charged, allows the system to reach a steady state speed, cleans the non-transferred residual toner from the drum, and erases recently-printed images from the photoconductive drum. Post rotation allows excess toner particles to be scraped from the surface of the cyan, magenta, yellow, or black photoconductive drums after a document has been printed. Thus, prerotation and post rotation can be considered as “overhead” associated with stopping and restarting one of the four photoconductive drums shown in FIG. 1. As each rotation of the drums requires a certain length of time, this overhead can impact the speed at which laser printer 105 prints documents.

In the embodiment of FIG. 1, laser printer 105 is capable of optimizing the need for printer speed with the need to reduce rotations of unused photoconductive drums and developers. It is contemplated that each photoconductive drum of laser printer 105 requires between ½ and 1 1/2 preprint and post print rotations. However, other embodiments of the invention may include laser printers having photoconductive drums that require a lesser or a greater number of preprint and post print rotations.

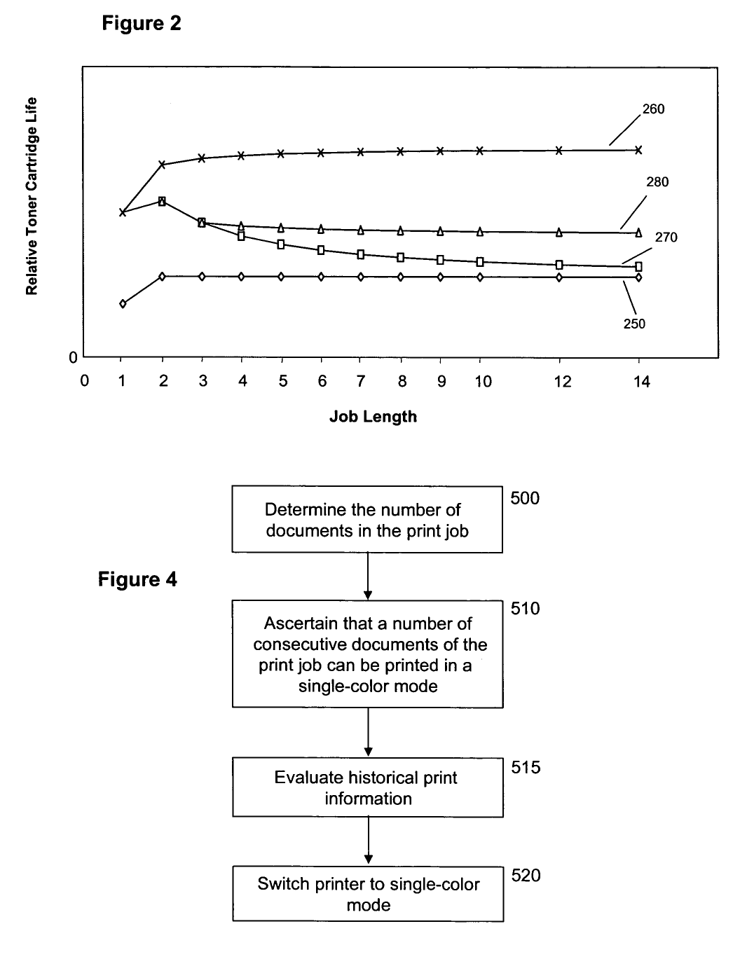

FIG. 2 is a graph showing a comparison of various criteria for print mode switching according to an embodiment of the invention. FIG. 2 was determined as a result of a simulation encompassing a mixture of print job lengths as well as a mixture of multicolor versus single-color documents within a given print job. In FIG. 2, relative toner cartridge life is shown on the vertical axis, while print job size is a shown on the horizontal axis.

Curve 250 of FIG. 2 shows the condition in which laser printer 105 does not switch off unused photoconductive drums and toner developers. This condition represents the shortest toner cartridge life as the photoconductive drum and the toner developer continue to rotate even though the printer is not printing color documents. However, since prerotations and post rotations are performed only before and after executing each print job, curve 250 can be expected to represent the fastest relative print speed.

Curve 260 of FIG. 2 also shows the condition in which the photoconductive drum and the associated toner developer are switched off in all cases. Thus, when DC controller 140 determines that as few as one upcoming document of a print job can be printed in a single-color mode, the DC controller switches off the photoconductive drum and the associated toner developer. As can be seen, this results in the largest relative toner cartridge life. However it can also be expected that due to the need for frequent prerotation and post rotation of the photoconductive drum and the associated toner developer, during which no printing is performed, curve 260 likely represents the slowest relative print speed.

Curve 270 of FIG. 2 shows the relative toner cartridge life as a function of job length for the condition of switching off an unused photoconductive drum when the first document can be printed using a single-color. An example of this is a full color brochure having a black and white front page. As expected, as the job length increases (for example, a job consisting of 20 documents) curve 270 approaches curve 250, thus showing the decreasing benefit provided by switching only at the first document of the print job when the job length increases. However, for shorter job lengths, such as five documents or fewer, it can be seen that curve 270 provides an increase in relative toner cartridge life.

Curve 280 shows the relative toner cartridge life as a function of job length for the condition of switching off an unused photoconductive drum when the first document of the print job can be printed in a single-color mode. Curve 230 also includes the condition in which the unused cartridge is switched off as a function of three or more consecutive documents of a print job requiring only single-color printing. As can be seen from FIG. 2, for shorter jobs, such as less than five documents, an increase in the relative toner cartridge life results (when compared to curve 270). As job length increases, the relative toner cartridge life maintains an advantage over curve 270.

In some embodiments of the invention, the decision to switch from a multicolor print mode to a single-color print mode may be influenced by the job size and composition of past print jobs. Thus, in the event that the user has a tendency to print jobs that are predominantly color documents, the criteria for switching from a multicolor to a single-color mode may become more restrictive since there is a high probability that any single-color document will be followed by a multicolor document. Thus, for example, if usage data indicates that 90 percent of the documents within a print job are multicolor, an unused cartridge may be switched off only after seven or more consecutive documents of a print job require only single-color printing. Conversely, if 90 percent of documents printed by a user are single-color, there may be a high probability that any color document within a print job will be followed by a single-color document. Thus, an unused cartridge might be switched off only after one or two consecutive documents of a print job require only single-color printing. Thus, by making use of historical printer usage information, the printer can balance the desire for maximizing printer speed (pages per minute) with the desire for maximizing photoconductive drum and toner developer life.

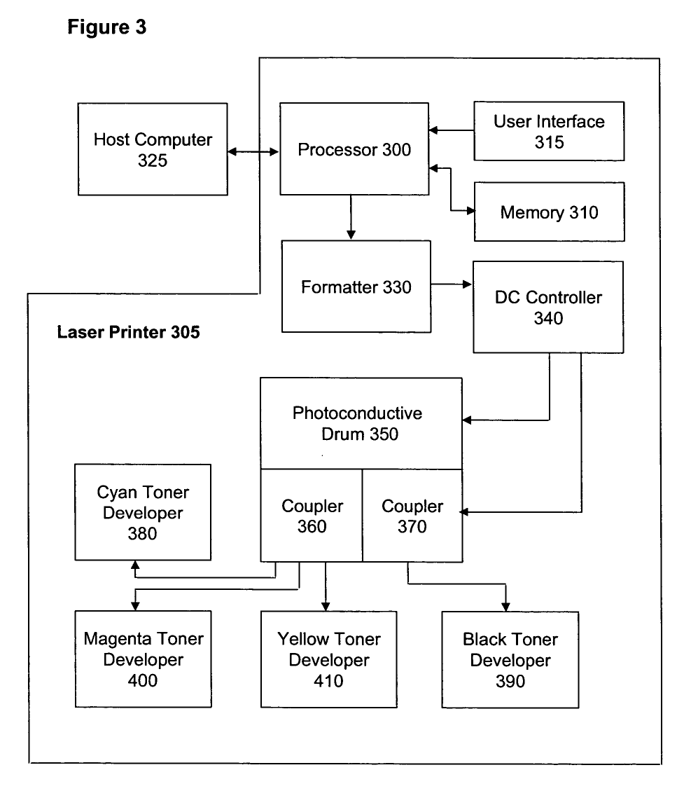

FIG. 3 is a block diagram of a system that performs print mode switching influenced by job length according to a second embodiment of the invention. In FIG. 3, host computer 325, processor 300, user interface 315, memory 310, and formatter 330 operate in a matter substantially similar to host computer 100, user interface 120, memory 160, and formatter 130 of FIG. 1. However, DC controller 340 of FIG. 3 controls the operation of a single photoconductive drum (350), as opposed to the DC controller of FIG. 1 (140) controlling the operation of four separate photoconductive drums. Additionally, DC controller 340 controls the state of couplers 360 and 370. Couplers 360 and 370 may be a clutch or other device that connects and disconnects cyan toner developer 380, magenta toner developer 400, and yellow toner developer 410 from photoconductive drum 350.

Laser printer 305 of FIG. 3 may offer a lower cost solution than laser printer 105 of FIG. 1 since fewer photoconductive drums are used in the architecture of FIG. 3. Laser printer 105 allows individual photoconductive drums (220, 210, 200, and 180) to be switched off independently, while laser printer 305 permits cyan toner developer 380, magenta toner developer 400, and yellow toner developer 410 are switched off as a single unit. However, given that many documents are printed either in a multicolor mode involving all four colors, or in a monochromatic mode that involves only toner from black toner developer 390, laser printer 305 may be adequate for many customers needs.

In other embodiments of the invention, at least some functionality performed by formatter 330 may be performed by host computer 325. Thus, in some embodiments, the conversion of the print job into raster image processing commands performed by formatter 330 may be performed by host computer 100. In this embodiment, using the processing resources of the host computer, which may be more extensive than the processing resources of laser printer 105, can result in shorter print job composition times.

Also in an embodiment in which raster image processing tasks are implemented in a host computer, determining the criteria used to switch from multicolor to single-color printing may also be more flexible than as described with reference to FIGS. 1 and 3. Thus, in embodiments where host computer 325 interfaces with a variety laser printers, each with a different value of drum prerotation and post rotation overhead, host computer 325 may consider this overhead in determining when to stop the rotation of a particular unused print drum. For example, in the event that a particular laser printer has larger value of prerotation and post rotation overhead, host computer 325 may switch off one or more unused photoconductive drums only after determining that four or five consecutive documents are to be printed in a single-color mode. In another example, where prerotation and post rotation overhead amounts are low, such as one-quarter rotation, host computer 325 may switch off one or more unused print photoconductive drums only after determining that one or two consecutive documents are to be printed in a single-color mode.

As FIGS. 1 and 3 illustrate, embodiments of the invention can be practiced in various printer architectures. Thus, some printer architectures may allow the shut down of individual photoconductive drums and toner developers. In other printer architectures, such as those in which both multicolor and single-color printed documents are routed across all of the printer's photoconductive drums, stopping or otherwise restricting the rotation of one or more drums may not be possible. In these architectures, it may be beneficial to stop or restrict the rotation of only the unused toner developers while other photoconductive drums continue to rotate. In still other architectures, it may be possible to stop the rotation of unused photoconductive drums and toner developers based on whether or not a portion of a document can be printed in a single-color mode. In this example, cyan, magenta, and yellow photoconductive drums and toner developers may only rotate while a multicolor illustration at the top of the document is printed and may cease to rotate while the single-color text portion near the bottom of the document is printed.

FIG. 4 is a flowchart for a method of print mode switching according to an embodiment of the invention. The apparatus of FIGS. 1 and 3 are suitable for performing the method. FIG. 4 begins at step 500 in which the number of documents in a print job is determined. At step 510, the number of consecutive documents of the print job that can be printed in a single-color mode is ascertained.

The method of FIG. 4 also includes step 515, however, other embodiments of the invention may exclude the step. In step 515, the printer evaluates historical print information as an indication of future print activity. Thus, in the event that the user historically prints very few color documents, the printer may determine that unused photoconductive drums and toner developers should be shut off after detecting that only a small number (perhaps one or two) of consecutive documents can be printed in a single-color mode. Conversely, in the event that the user historically prints a large number of color documents, the printer may determine that unused photoconductive drums and toner developers should be shut off only after detecting that a larger number (perhaps six or seven) of consecutive documents can be printed in a single-color mode.

At step 520, the printer is switched to a single-color mode based on one or more of steps 500, 510, and 515. Step 520 may also include decoupling at least one of a first and second rotating drum from a photoconductive drum that brings about the rotation of the first and second rotating toner developers. In one embodiment, switching step is performed after step 500 determines that the job length is greater than five documents and wherein step 510 ascertains that three consecutive documents can be printed in the single-color mode.

In conclusion, while the present invention has been particularly shown and described with reference to the foregoing preferred and alternative embodiments, those skilled in the art will understand that many variations may be made therein without departing from the spirit and scope of the invention as defined in the following claims. This description of the invention should be understood to include the novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

What is claimed is:

1. A method for controlling printing in a system that prints both single-color and multicolor documents, the method comprising:
determining the number of documents of a print job;
ascertaining that a number of consecutive documents of the print job can be printed in a single-color mode; and
switching the system to the single-color mode based on the ascertaining and the determining steps.

2. The method of claim 1, wherein the single-color mode causes documents to be printed using predominantly black toner.

3. The method of claim 1, wherein the multicolor documents are printed using at least one toner having at color selected from the group consisting of cyan, magenta, and yellow.

4. The method of claim 1, wherein the system includes a first rotating drum that deposits single-color toner onto a print media and a second rotating drum that deposits a second color toner onto the print media.

5. The method of claim 1, wherein the switching step includes decoupling at least one of a cyan, magenta, and yellow developer from a first rotating drum.

6. The method of claim 1, wherein the switching step is performed after the determining step determines that the print job is greater than five documents and wherein the ascertaining step ascertains that three consecutive documents can be printed in the single-color mode.

7. The method of claim 1, wherein the switching step includes determining an amount of overhead associated with switching to the single-color mode.

8. The method of claim 7, wherein the overhead includes an amount of preprint rotation that one or more rotating drums must perform prior to printing a multicolor document.

9. The method of claim 8, wherein the overhead includes an amount of post print rotation that one or more rotating drums must perform after printing a multicolor document.

10. The method of claim 1, additionally comprising evaluating historical print information as an indication of future print activity, the evaluating step being performed after the ascertaining step.

11. A printing device that prints both single and multicolor documents of a print job, comprising:
a plurality of rotating drums, each of which deposits toner onto a medium;
a formatter for converting the print job into a series of raster commands;
a controller that controls the rotation of the plurality of rotating drums; wherein
as a function of the number of documents of the print job and the number of consecutive documents of the print job that can be printed in a single-color mode, the controller causes at least one of the plurality of rotating drums to come to a stop while at least one other of the plurality of rotating drums continues to rotate.

12. The printing device of claim 11, wherein the controller additionally makes use of historical print information to cause at least one of the plurality of rotating drums to come to a stop.

13. The printing device of claim 11, wherein the single-color is predominantly black, and wherein the colors other than the single-color are at least one of the group consisting of cyan, magenta, and yellow.

14. The printing device of claim 11, wherein the function includes overhead required by the printing device to switch from the single-color mode to a multicolor mode.

15. The printing device of claim 14, wherein the overhead includes a number of preprint rotations that one or more rotating drums perform prior to printing a multicolor document.

16. The printing device of claim 11, wherein the function includes overhead required by the printing device to switch from a multicolor mode to the single-color mode.

17. The printing device of claim 16, wherein the overhead includes a number of post print rotations that one or more rotating drums perform after printing a multicolor document.

18. A system that prints both single-color and multicolor documents, comprising:
means for determining the number of documents in the print job;
means for determining that a number of consecutive documents of the print job are to be printed using a single color of toner; and
means for switching the printer from a multicolor mode to a single-color mode based on the determined number of documents and the determined number of consecutive documents of the print job that are to be printed using a single-color of toner.

19. The system of claim 18, wherein the single-color mode provides black and white printed documents.

20. The system of claim 18, wherein the multicolor mode provides documents printed with at least one of cyan, magenta, and yellow toner.

21. The system of claim 18, further comprising means for restricting the rotation of at least one rotating drum, the means for restricting being coupled to the means for switching.

22. The system of claim 21, wherein the means for restricting the rotation of the at least one rotating drum includes a clutch that couples at least one photoconductive drum to at least one toner developer.

23. The system of claim 18, wherein the means for restricting the rotation of the at least one rotating drum includes means for switching off power to the at least one rotating drum.
